(19) United States
(12) Patent Application Publication
(10) Pub. No.: US 2013/0153601 A1
(43) Pub. Date: Jun. 20, 2013

(54) DRINKING-WATER DISPENSER

(71) Applicant: Guglielmo Martelli, Amsterdam (NL)

(72) Inventor: Guglielmo Martelli, Amsterdam (NL)

(21) Appl. No.: 13/695,926

(22) PCT Filed: May 3, 2011
(86) PCT No.: PCT/IB11/00944

§ 371 Date: Mar. 6, 2013

(30) Foreign Application Priority Data
May 3, 2010 (IT) BA2010A000276
May 3, 2010 (IT) BA2010A000277
May 3, 2010 (IT) BA2010A000278

(51) Int. Cl. B65D 35/56; B67D 7/06

(52) U.S. Cl. CPC B67D 3/00
USPC 222/105; 222/185.1

(57) ABSTRACT

A drinking-water dispenser comprising: a containment chamber for the water; a delivery device, which is designed to enable or prevent outlet of the water from the containment chamber so as to enable a user to draw off water from the dispenser; a connection device for enabling installation of a replaceable refill reservoir on the dispenser and for setting the dispenser and the refill reservoir in fluid communication; and a collector, which in turn comprises a substantially limp sac set within the containment chamber and connected in a releasable way to the connection device and to the delivery device.

### TECHNICAL FIELD

The present invention relates to a dispenser of liquids (in particular, of at least one beverage, and more in particular, drinking water), use of a collector, a kit, and use of said kit.

### BACKGROUND

In offices, canteens, and normal dwellings there is increasing spread of dispensers of liquids, in particular drinking water, in which pre-filled refill reservoirs are used.

In such dispensers a full refill is inserted when a previous refill is exhausted, i.e., when all the water contained therein has been used. Obviously, the previous empty refill is removed from the dispenser, before insertion of a new refill full of liquid.

Typically, dispensers of this sort comprise a containment chamber within which the water present in the refill reservoir is supplied by gravity.

In some cases, the containment chambers can be cooled and/or heated so as to enable the user to draw off hot water and/or cold water according as needed.

Drinking-water dispensers of a known type have various drawbacks, amongst which the fact that cleaning and hygiene of the containment chamber/chambers can be obtained only through very frequent maintenance and cleaning operations. These operations are extremely complex, problematical, and long and consequently require long periods in which the dispenser cannot in actual fact be used.

It should be noted that the quality of the water that is drawn off and then drunk by users is indissolubly linked to the hygiene and cleanliness of the containment chamber. Consequently, a non-frequent maintenance and/or cleaning of the dispensers can lead to waters with bad tastes and/or high bacterial charges (with consequent evident risks for health).

### SUMMARY

The aim of the present invention is to provide a dispenser of liquids (in particular, of at least one beverage; more in particular, drinking water), use of a collector, a kit, and use of said kit that will be free from the drawbacks described above and, at the same time, will be convenient and economically advantageous to produce.

According to the present invention, a dispenser of liquids (in particular, of at least one beverage; more in particular, drinking water), use of a collector, a kit, and use of said kit are provided according to what is specified in the independent claims, or else in any one of the claims that depend either directly or indirectly upon the independent claims.

### BRIEF DESCRIPTION OF THE DRAWINGS

The invention is described in what follows with reference to the annexed drawings, which illustrate some non-limiting examples of embodiment thereof and in which:

FIG. 1 is a schematic illustration of a collector, use of which is in accordance with the present invention;

FIG. 2 is a schematic illustration of a dispenser, which, when combined with the collector of FIG. 1, defines a dispenser according to the present invention;

FIG. 3 illustrates a web from which a sac forming part of the collector of FIG. 1 can be obtained; and

FIG. 4 is cross-sectional view of the web of FIG. 3.

### EMBODIMENTS OF THE INVENTION

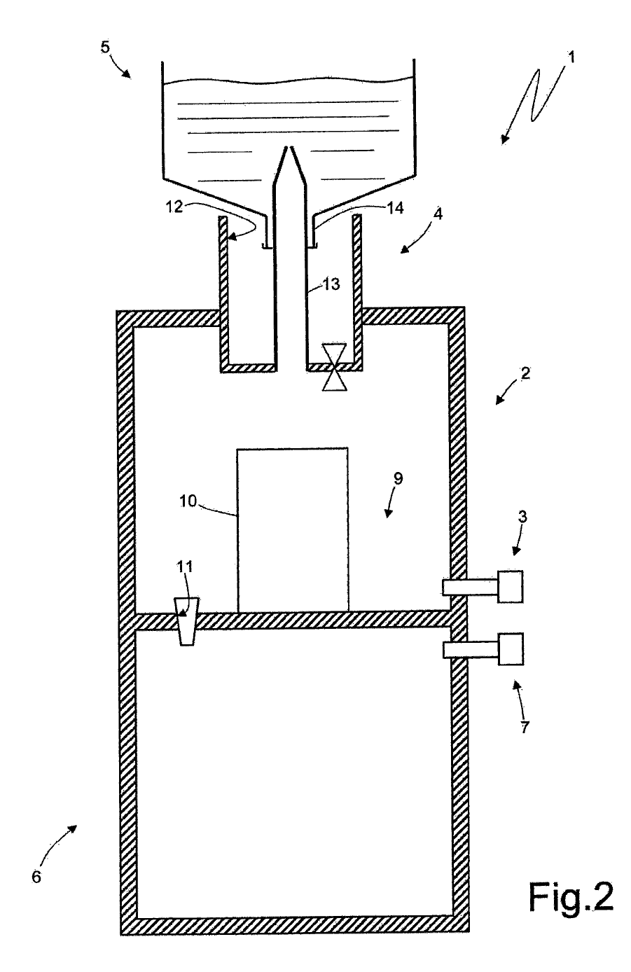

In FIG. 2 designated as a whole by 1 is a dispenser of liquids (in particular, of at least one beverage; more in particular, drinking water). The dispenser 1 comprises: a containment chamber 2 for the beverage; a delivery device 3; and a connection device 4 for enabling installation of a replaceable refill reservoir 5 on the dispenser 1 and for setting the dispenser 1 in fluid communication with the refill reservoir 5.

The delivery device 3 is designed to enable or prevent outlet of the beverage from the containment chamber 2 so as to enable a user to draw off the beverage from the dispenser 1. Typically, the delivery device 3 comprises a tap.

According to the shown embodiment, the dispenser 1 comprises a further containment chamber 6 connected to a further delivery device 7. The containment chambers 2 and 6 are differentiated, since the beverage present in the containment chamber 2 is cooled by means of a cooling device 9, whereas the beverage present in the chamber 6 is heated by means of heater means (not illustrated—typically, electrical resistors).

The cooling device 9 comprises a cooling element 10 set within the containment chamber 2 and jutting out from an inner surface of the chamber 2 itself.

An opening 11 sets the containment chambers 2 and 6 in connection.

The connection device 4 comprises a seat 12, set within which is a pointed sleeve 13 and mounted in which, in use, is a neck (oriented downwards) of the refill reservoir 5. In particular, when the refill reservoir 5 is mounted on the dispenser 1, the sleeve 13 (which is hollow and open at the ends) extends within the reservoir 5 so as to enable passage of the beverage from the reservoir 5 to the chamber 2.

The dispenser 1 further comprises a collector 15, which in turn comprises a container 16. The collector 15 is set within the chamber 2. The collector 15 is designed to enable passage of the beverage from the connection device 4 to the delivery device 7 without the beverage itself coming into contact with the inner surface of the containment chamber 2. In this way, the possibility within the chamber 2 of creation of deposits (for example, lime) and/or of development of bacteria and/or of onset of other problems of a hygienic nature is limited in a practically total way. In this regard, it should be emphasized that the collector 15 can be removed and replaced easily whenever desired so as to maintain a high quality of the beverage delivered by the dispenser 1. Advantageously, the collector 15 is of the disposable type and, once used, does not need to be washed, but can be directly thrown away (after being replaced by another “new” collector 15).

Advantageously, the container 16 comprises (more in particular, is) a (substantially) limp sac, i.e., a sac that has a different shape when it is empty and when it is full (filled with a fluid). In particular, the volume of a (substantially) limp sac when full (i.e., filled with a fluid) is several times (at least three times) greater than that of the same sac when it is substantially empty. It should be noted that the (substantially) limp sac has numerous advantages as compared to a rigid container. For example, the (substantially) limp sac is relatively simple and inexpensive to produce, light, and manageable.

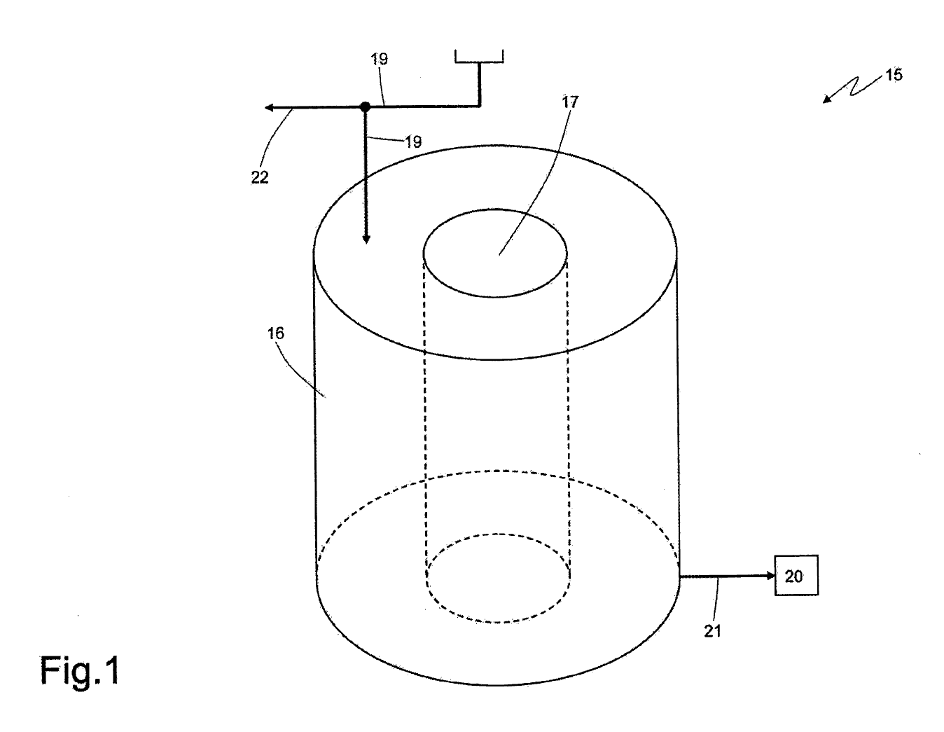

FIG. 1 is a schematic illustration of a collector 15 in which the container (in particular, the sac) 16 is full. According to the embodiment illustrated in said figure, the container (or the sac 16 when full) has a shape compatible with the position and the shape of the cooling element 10. In particular, the container 16 has a shape such as to extend around the cooling element 10. The container 16 is shaped in such a way as to have a through channel 17.

The container 16 is in (substantially fluid-tight) fluid communication with the connection device 4 and with the delivery device 3. The collector 15 is releasably joined to the connection device 4 and to the delivery device 3.

The collector 15 comprises a coupling element 18, which connects in a fluid-tight (and releasable) way the container 16 to the connection device 4 (in particular, to the sleeve 13). In particular, the coupling element 18 connects a duct 19 in a fluid-tight way to the connection device 4. The duct 19 extends between the container 16 and the device 4 so as to set the container 16 and the connection device 4 in fluid communication. More in particular, the coupling element 18 is designed to be coupled (for example, by means of screwing) to an element of a shape complementary to that of the device 4. Advantageously, the duct 19 forms part of the collector 15.

The collector 15 comprises a coupling element 20, which connects the container 16 to the delivery device 3 in a fluid-tight (and releasable) way. In particular, the coupling element 20 connects a duct 21 to the delivery device 3 in a fluid-tight way. The duct 21 extends between the container 16 and the delivery device 3 so as to set the container 16 and the delivery device 3 in fluid communication. More in particular, the coupling element 20 is designed to be coupled (for example, by means of screwing) with an element of a shape complementary to that of the delivery device 3. Advantageously, the duct 21 forms part of the collector 15.

The container 16 has openings in which ducts 19 and 21 are inserted.

According to some embodiments (where the presence of the coupling element 20 is not necessary), the duct 21 is deformable. In this case, the delivery device 3 comprises: a pressure device (not illustrated, for example a pressure element pushed by a spring) for deforming (squeezing) the duct so as to prevent substantially flow along the duct 21 itself; and a release device (not illustrated, for example a lever for moving away the pressure element from the duct 21) for governing operation of the pressure device.

The dispenser 1 (in particular, the collector 15) comprises a duct 22, which extends from the duct 19 to the chamber 6, in particular through to the opening 11. The duct 22 is designed to send part of the beverage to the chamber 6 so that part of said beverage can be heated.

According to some embodiments, all the ducts 19, 21, 22 are made of deformable plastic material.

It should be emphasized that the collector 15 is completely removable and replaceable in a simple and fast way whenever desired. In this way, it is possible to keep the beverage contained in the chamber 2 substantially always in an aseptic and clean environment, at the same time reducing the costs and times for maintenance of the dispenser 1.

According to a further aspect of the present invention a collector 15 as defined above is also provided as such (i.e., separate from the dispenser 1).

According to a further aspect of the present invention, use of the collector 15 is also provided.

According to a further aspect of the present invention, a kit for prearranging the collector 15 for the dispenser 1 is also provided. In particular, the kit serves (is used) for inserting (mounting) the collector 15 in the dispenser 1.

Advantageously, the kit is substantially sterile. The kit comprises the various elements of the collector 15 as described above. Said components may be already assembled together or else are to be assembled together. According to some embodiments, the kit comprises the collector 15 as defined above and not combined with the dispenser 1.

In the case where the ducts 19 and 21 are not already connected to the container 16, the kit includes a first perforating element and a second perforating element (not illustrated), which are hollow and are designed to perforate the container 16 to set the container 16 in fluid communication with the duct 19 and with the duct 21, respectively. According to some embodiments, the perforating elements are hollow wedges.

In some cases, the first and second perforating elements are mounted on an end of the ducts 19 and 21, respectively.

The kit as defined above can be used in a dispenser 1 as defined above. In particular, the kit can be used for replacing the collector 15 present within the dispenser 1 in order to restore optimal conditions of hygiene and cleanliness in an easy, fast, and inexpensive way.

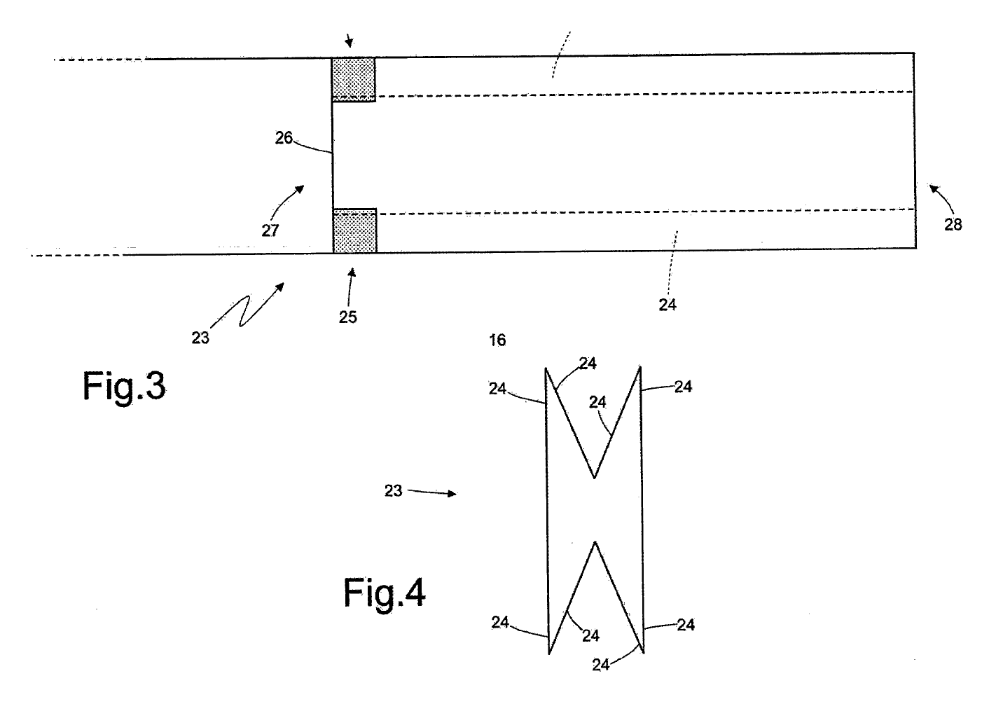

FIGS. 3 and 4 illustrate how the container (in the case in point the sac) 16 can be obtained. A tubular web 23 folded in bellows fashion (like the one illustrated in FIG. 4) so as to have side layers 24 set on top of one another, is cut and sealed long the line 26 so as to obtain a separate length of web. The separate length is folded in a loop so as to set the ends 27 and 28 on top of one another, which are then welded together.

The above operations starting from the web 23 are repeated for a number of times equal to the number of sacs 16 that are to be obtained.

The tubular web 23 can be treated thermally, by advantageously performing the same operation as that for welding the ends 27 and 28, in areas 25 in such a way that in said areas 25 the side layers 24 set on top of one another bond together so as to obtain an area in which the perforating elements can advantageously perforate the container 16 and in which they can be housed.

1. A dispenser of at least one beverage, the dispenser (1) comprising: at least one containment chamber (2) for the beverage; at least one delivery device (3), which is designed to enable or prevent outlet of the beverage from the containment chamber (3) so as to enable a user to take the beverage out of the dispenser (1); and at least one connection device (4) for enabling installation of a replaceable refill reservoir (5) on the dispenser (1) and for setting the dispenser (1) and the refill reservoir (5) in fluid communication; the dispenser (1) being characterized in that it comprises a collector (15), which in turn comprises a container (16) set within the containment chamber (2) and in substantially fluid-tight fluid communication with the connection device (4) and with the delivery device (3); the collector being releasably joined to the connection device (4) and to the delivery device (3).

2. The dispenser according to claim 1, wherein the container comprises a substantially non rigid bag (16).

3. The dispenser according to claim 1 or claim 2, and comprising a first coupling element (18), which connects the container (16) to the connection device (4) in a fluid-tight way.

4. The dispenser according to claim 1, and comprising a second coupling element (20) that connects the container (16) to the delivery device (3) in a fluid-tight way.

5. The dispenser according to claim 1, and comprising a first duct (19), which extends between the container (16) and the connection device (4) so as to set the container (16) and the connection device (4) in fluid communication.

6. The dispenser according to claim 5, wherein the first duct (19) extends from the container (16) to a first coupling element (18); the connection device (4) comprises an element, which is complementary to the first coupling element (18) with which the first coupling element (18) is connected in a substantially fluid-tight and releasable way.

7. The dispenser according to claim 5, and comprising a second duct (22), which extends from the first duct (19) to a further containment chamber (6); heater means being set in the area of the further containment chamber (6).

8. The dispenser according to claim 1, and comprising a third duct (21) that extends between the container (16) and the delivery device (3) so as to set the container (16) and the delivery device (3) in fluid communication.

9. The dispenser according to claim 8, wherein the third duct (21) is deformable; the delivery device (3) comprising: a pressure device for deforming the third duct (21) so as to substantially prevent flow along the third duct (21) itself; and a release device for governing operation of the pressure device.

10. The dispenser according to claim 8, wherein the third duct (21) extends from the container (16) to a second coupling element (20); the delivery device (3) comprising a further element, which is complementary to the second coupling element (20) and with which the second coupling element (20) is connected in a substantially fluid-tight and releasable way.

11. The dispenser according to claim 1, and comprising a cooling device (9), which comprises at least one cooling element (10) at least partially set within the containment chamber; the container (16) having a shape compatible with the position and the shape of the cooling element.

12. The dispenser according to claim 1, comprising a cooling device, which in turn comprises at least one cooling element set within the containment chamber and jutting out from an inner surface of the containment chamber (2); the container having a shape such as to extend about the cooling element.

13. Use of a collector (15) in a dispenser (1) of at least one beverage, the dispenser (1) comprising: at least one containment chamber (2) for the beverage; at least one delivery device (3), which is designed to enable or prevent outlet of the beverage from the containment chamber (2) so as to enable a user draw off the beverage from the dispenser (1); and a connection device (4) for enabling installation of a replaceable refill reservoir (5) on the dispenser (1) and setting the dispenser (1) and the refill reservoir (5) in fluid communication; the collector (15) comprising a container (16), which in turn comprises a first opening and a second opening; the container (16) being set within the containment chamber (2) and being connected to the connection device (4) and to the delivery device (3) so that the beverage coming from the connection device (4) enters the container (16) through the first opening and exits from the container (16) itself through the second opening and reaches the delivery device (3).

14. Use according to claim 13, wherein the container comprises a substantially non rigid bag (16).

15. Use according to claim 13, wherein the collector comprises a first coupling element (18), which is coupled to the connection device (4) for connecting the container (16) in a fluid-tight way to the connection device (4).

16. Use according to claim 15, the collector (5) comprising a first duct (19), which extends from the container (16) to the first coupling element (18).

17. Use according to claim 16, the collector (15) comprising a second duct (22), which extends from the first duct (19).

18. Use according to claim 13, wherein the collector (15) comprises a second coupling element (20), which is coupled to the delivery device (3) for connecting the container (16) in a fluid-tight way to the delivery device (3).

19. Use according to claim 13, wherein the collector (15) comprises a third duct (21), which extends from the container (16).

20. Use according to claim 18, wherein the collector (15) comprises a third duct (21), which extends from the container (16) to the second coupling element (20).

21. Use according to claim 19 or claim 20, wherein the third duct (21) is deformable.

22. Use according to claim 13, wherein the container (16) is shaped in such a way as to have a through channel (17).

23. Use according to claim 13, wherein the collector (15) is sterilized before being mounted in the dispenser (1).

24. Use according to claim 13, wherein the collector (15) and the dispenser (1) are defined in accordance with claim 1.

25. A kit for a collector (15) for a dispenser (1) of at least one beverage; the kit being substantially sterile and comprising a: container (16), which is designed to contain the beverage; a first and at least one second duct (19, 21); and at least one first coupling element (18) for connecting the first duct (19) to a connection device (4) of the dispenser (1).

26. The kit according to claim 25, wherein the container comprises a substantially non rigid bag (16).

27. The kit according to claim 25, wherein the first duct (19) and/or the second duct (21) is/are in fluid communication and connected in a substantially fluid-tight way to the container (16).

28. The kit according to claim 25, and comprising a first perforating element and a second perforating element, which are hollow and are designed to perforate the container (16) to set the container in fluid communication with the first duct (19) and the second duct (21), respectively.

29. The kit according to claim 28, wherein the first and second perforating elements are each mounted on an end of the first and second ducts (19, 21), respectively.

30. The kit according to claim 25, and comprising a second coupling element (20) for connecting the second duct (21) to a delivery device (3) of the dispenser (1).

31. The kit according to claim 30, wherein the second coupling element (20) is mounted on an end of the second duct (21).

32. The kit according to claim 25, wherein the first coupling element (18) is mounted on an end of the first duct (19).

33. The kit according to claim 25, wherein the second duct (21) is deformable so as to enable it to be substantially occluded by deformation.

34. The kit according to claim 25, and comprising a third duct (22) which extends from the first duct (19).

35. The kit according to claim 25, wherein the container (16) is shaped in such a way as to have a through channel (17).

36. The kit according to claim 25, wherein the collector (15) and the dispenser (1) are defined in accordance with claim 1.

37. Use of a kit according to claim 25 in a dispenser (1) comprising: at least one containment chamber (2) for the beverage; at least one delivery device (3), which is designed to enable or prevent outlet of the beverage from the containment chamber (3) so as to enable a user to take the beverage out of the dispenser (1); and a connection device (4) for enabling installation of a replaceable refill reservoir (5) on the dispenser (1) and for setting the dispenser (1) and the refill reservoir (5) in fluid communication; the first duct being mounted so as to set the container and the connection device in fluid communication; the second duct being mounted so as to set the container and the delivery device in fluid communication.
